(19) United States
(12) Patent Application Publication
(10) Pub. No.: US 2013/0222306 A1
(43) Pub. Date: Aug. 29, 2013

(54) ELECTRONIC DEVICE AND METHOD FOR DETERMINING A TEMPERATURE OF AN ELECTRONIC DEVICE

(71) Applicant: SONY MOBILE COMMUNICATIONS AB, (US)

(72) Inventors: Peter ABERG, Vinslov (SE); Lars KNUTSSON, Sjobo (SE); Magnus MIDHOLT, Lund (SE); Bjorn ROSQVIST, Lund (SE)

(21) Appl. No.: 13/778,808

(22) Filed: Feb. 27, 2013

Related U.S. Application Data
(60) Provisional application No. 61/604,045, filed on Feb. 28, 2012.

(30) Foreign Application Priority Data
Feb. 28, 2012 (EP) 12 001 308.1

(51) Int. Cl. G01K 7/16; G06F 3/041

(52) U.S. Cl. CPC G01K 7/16; G06F 3/0414
USPC 345/173; 374/185

(57) ABSTRACT

An electronic comprises at least one strain gauge arranged at the electronic device such that a strain of the at least one strain gauge is influenced by a change of a temperature of the electronic device and a control assembly for evaluating an output signal of the at least one strain gauge to determine a temperature of the electronic device on the basis of the output signal and for controlling at least one function of the electronic device based on the determined temperature.

### FIELD OF INVENTION

The present invention relates to an electronic device, a touch user interface for an electronic device, especially an electronic device comprising the touch user interface, and a method for determining a temperature of an electronic device.

### BACKGROUND OF THE INVENTION

Touch screens are known in the art for controlling devices via a user interface. Touch-sensitive proximity sensing components may be arranged on top of a display forming a so-called touch screen. A touch screen provides a very intuitive way of operating the device. Information may be displayed on the display; in response to the information displayed on the display, the user may touch the display for initiating actions or operations. The touch screen may work by detecting a change of capacity when the user approaches or touches the surface of the touch screen. Such a so-called capacitive touch screen may also provide location information on a position where the user touches the touch screen. This may be used to provide a two-dimensional input means as the user interface. However, especially in connection with complex applications, a three-dimensional input means may be desirable. A third input dimension may be accomplished by measuring a force being applied by the user to the surface of the touch screen. A strain gauge may be used for force sensing. Using a strain gauge sensor may be very effective in measuring strain on for example a glass window created by a force applied by the user. However, strain gauge sensors are very sensitive to environmental effects such as temperature changes.

It is desirable to measure temperature changes and pure temperature on surfaces on for example an electronic device with for example a strain gauge if the caused strain is not influenced by any force.

There is a need to provide a simple, cheap, reliable and robust way of measuring a temperature change or pure temperature on electronic devices.

### SUMMARY OF THE INVENTION

According to an aspect of the present invention, an electronic device is provided. The electronic device has at least one strain gauge which is arranged at the electronic device such that a strain of the at least one strain gauge is influenced by a change of a temperature of the electronic device. Further, the electronic device has a control assembly for evaluating an output signal of the at least one strain gauge to determine a temperature of the electronic device on the basis of the output signal and for controlling at least one function of the electronic device based on the determined temperature.

According to an embodiment, the at least one strain gauge is part of a force detection arrangement of the electronic device. The force detection arrangement is provided for detecting a force exerted on the electronic device. Further, the force detection arrangement may be adapted to detect a force exerted on a touch screen of the electronic device.

According to an embodiment, the at least one strain gauge may be arranged such that the strain of the at least one strain gauge is influenced by a change of a temperature of a display or a touch screen of the electronic device. The control assembly may be adapted to determine the temperature of the display or touch screen of the electronic device and to control the at least one function of the electronic device based on the determined temperature of the display or touch screen of the electronic device.

According to an embodiment, the at least one strain gauge comprises indium tin oxide. The indium tin oxide (ITO) may be coated on a glass surface in a thin layer for example in the form of a meander for realizing a strain gauge sensor configured to detect a strain on the glass window created by a force or created by a temperature on the glass window. As a thin layer of indium tin oxide has a high transparency, the constituted strain gauge sensor may be arranged on a top of a display for constituting a touch screen of a user interface. The layer of indium tin oxide may be overlaid onto the display such that the light output by the display process through the strain gauge sensor. If the material is coated outside the display area, there are several different materials to choose from.

According to an embodiment, the at least one strain gauge is arranged in a leg of a Wheatstone bridge circuit. The Wheatstone bridge may be adapted to determine a resistance and changes in a resistance very accurately, especially if the changes are very small. Thus the sensor value may be determined with high accuracy.

According to an embodiment, the at least one strain gauge is arranged at a surface region of the electronic device such that the strain of the at least one strain gauge is influenced by a change of a temperature at the surface region of the electronic device.

According to an embodiment, the at least one function of the electronic device is a function of a heat management system of the electronic device. The heat management system can arrange to clock down or even shut down the electronic device in order not to exceed internal temperature limits and temperature limits on the electronic device surface or charging of the electronic device can be stopped.

According to an embodiment, the electronic device is a mobile device selected from a group consisting of a mobile phone, a personal digital assistant, a mobile music player, a mobile computer, a tablet computer, and a mobile navigation system.

According to another aspect of the invention, a touch sensitive user interface for an electronic device is provided which comprises a force detection arrangement and a control assembly. The force detection arrangement comprises at least one sensor for detecting a force exerted by a user on a surface of the touch sensitive user interface. The control assembly evaluates an output signal of the at least one sensor to determine a temperature of the touch sensitive user interface on the basis of the output signal and to generate a control signal to control at least one function of the electronic device.

An electronic device may be configured to comprise the touch user interface as described above.

According to an aspect, a method for determining a temperature of an electronic device is provided. According to the method, at least one strain gauge is arranged at the electronic device such that a strain of the at least one strain gauge is influenced by a change of a temperature of the electronic device. Then, an output signal of the at least one strain gauge is evaluated to determine a temperature of the electronic device on the basis of the output signal.

The method may be performed using the above-described electronic device of any aspect or embodiment.

According to an embodiment, the method for determining a temperature of a user interface of an electronic device comprises detecting an output signal of at least one sensor of a force detection arrangement of the touch sensitive user interface, wherein the at least one sensor of the force detection arrangement is provided for detecting a force exerted by a user on a surface of the touch sensitive user interface, and determining a temperature of the touch sensitive user interface on the basis of an evaluation of the output signal of the at least one sensor.

Although specific features described in the above summary and in the following detailed description are described in connection with specific embodiments and aspects, it is to be understood that the features of the embodiments and aspects may be combined with each other unless specifically noted otherwise.

### BRIEF DESCRIPTION OF THE DRAWINGS

The invention will now be described in more detail with reference to the accompanying drawings.

FIG. 1 shows schematically a mobile device according to an embodiment of the present invention.

FIG. 2 shows an electronic device comprising a Wheatstone bridge according to an embodiment of the invention.

FIG. 3 shows method steps of a method according to an embodiment of the present invention.

### DETAILED DESCRIPTION OF PREFERRED EMBODIMENTS

In the following, exemplary embodiments of the invention will be described in more detail. It has to be understood that the following description is given only for the purpose of illustrating the principles of the invention and is not to be taken in a limiting sense. Rather, the scope of the invention is defined only by the appended claims and is not intended to be limited by the exemplary embodiments hereinafter.

It is to be understood that the features of the various exemplary embodiments described herein may be combined with each other unless specifically noted otherwise.

FIG. 1 shows an electronic device 1, for example a mobile phone. The electronic device 1 comprises among other parts (not shown) a display 2 and a touch screen 3 which is arranged on top of the display 2. The touch screen 3 may comprise a glass window and an array or grid of electrodes (not shown) for detecting that a user's finger approaches a certain position on the touch screen 3. Capacitive sensing may be performed, such that spatially resolved touch sensing is realized by electing a change of capacitance of electrodes as it is known in the art.

Furthermore, the touch screen 3 comprises at least one strain gauge sensor 4 arranged on a surface of the touch screen 3. The at least one strain gauge sensor 4 is part of a force detection arrangement of the electronic device 1. The force detection arrangement is provided for detecting a force exerted on the electronic device 1, especially a force exerted on a touch screen 2 of the electronic device 1. The strain gauge sensor 4 may comprise a layer of indium tin oxide. The strain gauge sensor 4 may be coated or laminated on the surface of the touch screen 3. The strain gauge sensor 4 may comprise an electric meander line as shown in FIG. 1 or an electric line of any other shape appropriate to detect a strain on the touch screen 3. If there is no force causing a strain of the strain gauge sensor 4, the strain of the strain gauge sensor 4 is created by a temperature or temperature change. The at least one strain gauge sensor 4 is arranged such that the strain of the at least one strain gauge 4 is influenced by a change of a temperature of the display 2 or the touch screen 3. The strain gauge sensor 4 may be formed as a trace of a suitable material, such as indium tin oxide. Conductive lines may be provided to connect portions of the strain gauge sensor 4 to a control assembly 5. For illustration, an end or both ends of the trace forming the strain gauge sensor 4 may be connected to the control assembly 5.

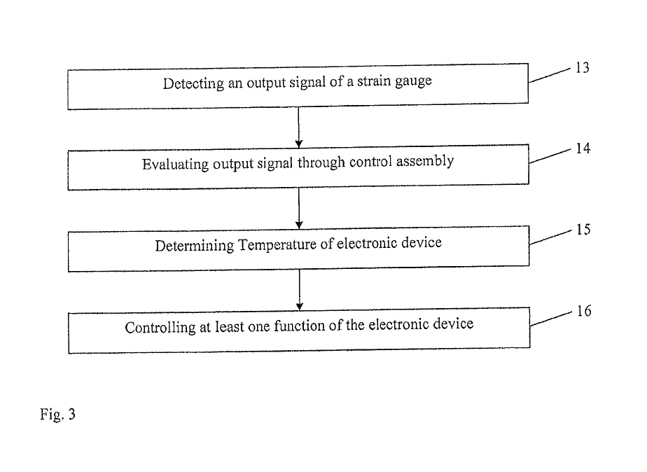

Operation of the control assembly 5 will be now described with reference to FIGS. 1 and 3.

FIG. 3 is a flow chart of a method of an embodiment. The at least one strain gauge 4 is implemented in an electronic device 1 for determining a strain created by a change of temperature of the electronic device 1. The change of temperature gives rise to an output signal of the at least one strain gauge 4. The change of temperature is detected by the control assembly 5 (Step 13). The control assembly 5 further evaluates the output signal of the at least one strain gauge 4 and determines the temperature of the electronic device on the basis of the output signal (step 15, step 16). The determined temperature is used to control at least one function of the electronic device 1 based on the temperature (step 16). The at least one function of the electronic device 1 is a function of a heat management system 6 of the electronic device 1. The at least one function of the heat management system 6 may comprise that the electronic device 1 is clocked or finally shut down if the electronic device 1 gets too hot, in order not to exceed internal temperature limits but also not to exceed temperature limits on the surface of the electronic device 1.

The electronic device 1 may be a mobile device selected from a group consisting of a mobile phone, a personal digital assistant, a mobile music player, a mobile computer, a tablet computer, and a mobile navigation system.

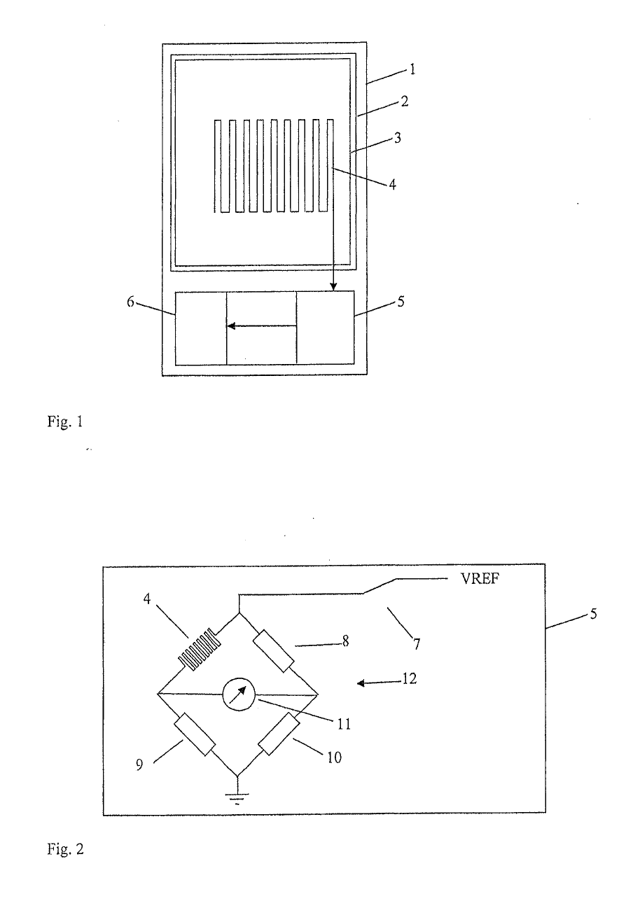

One function of the electronic device can be measuring a strain caused by a force. In FIG. 2, an embodiment for determining the resistance of the strain gauge sensor 4 using a Wheatstone bridge 12 is shown. A strain gauge sensor 4 is provided in at least one leg, in particular in each of a plurality of legs of a Wheatstone bridge 12. The other legs of the Wheatstone bridge 12 comprise resistors 8, 9, 10. As shown in FIG. 2, in at least one leg of the Wheatstone bridge 12 a strain gauge sensor 4 is coupled. The Wheatstone bridge 12 can be selectively supplied with a reference voltage VREF. The resistance of the strain gauge sensor 4 may be determined by the Wheatstone bridge 12 using conventional techniques, for example by balancing resistors (not shown) such that a voltage measured at a voltage measuring unit (not shown) becomes zero. Alternatively or additionally the resistance of the strain gauge sensor 4 may be determined based on the voltage indicated by the voltage measuring unit (not shown). The material of the strain gauge sensor 4, for example an indium tin oxide (ITO) material, follows different curves of resistance versus temperature and strain when being supplied with different supply voltages. Thus, there are two unknown parameters, the strain and the temperature. Due to the two measurements at different electrical supply voltages, both of these two unknown parameters can be determined. In particular, by evaluating the resistances measured for two supply voltages, resistance changes caused by a temperature change may be discriminated from resistance changes causes by a force applied onto the touch screen 3. Based on the characteristic dependencies of the at least one strain gauge sensor 4 indicating the resistance of the strain gauge sensor versus temperature, a temperature can be determined, if there is no strain change caused by a force. The read strain gauge value is compared to a known base-line and further the temperature can be calculated.

While exemplary embodiments have been described above, various modifications may be implemented in other embodiments. For example, the pattern and position of the strain gauge sensor 4 may have a shape other than the shape shown in FIG. 1, for example a zigzag shape. Furthermore, the characteristic dependencies indicating the change of temperature of the strain gauge sensor 4 may be implemented as a characteristic diagram, a look-up table or a mathematical formula.

Finally, it is to be understood that various modifications of the embodiments described above are considered to be comprised by the present invention as it is defined by the appended claims.

1. An electronic device comprising:
at least one strain gauge arranged at the electronic device such that a strain of the at least one strain gauge is influenced by a change of a temperature of the electronic device, and
a control assembly for evaluating an output signal of the at least one strain gauge to determine a temperature of the electronic device on the basis of the output signal and for controlling at least one function of the electronic device based on the determined temperature.

2. The electronic device according to claim 1,
wherein the at least one strain gauge is part of a force detection arrangement of the electronic device, the force detection arrangement being provided for detecting a force exerted on the electronic device.

3. The electronic device according to claim 2,
wherein the force detection arrangement is adapted to detect a force exerted on a touch screen of the electronic device.

4. The electronic device according to claim 1,
wherein the at least one strain gauge is arranged such that the strain of the at least one strain gauge is influenced by a change of a temperature of a display or a touch screen of the electronic device; and
wherein the control assembly is adapted to determine the temperature of the display or the touch screen of the electronic device on the basis of the output signal of the at least one strain gauge and controls the at least one function of the electronic device based on the determined temperature of the display or touch screen of the electronic device.

5. The electronic device according to claim 1,
wherein the at least one strain gauge arranged on the surface of the display comprises a transparent material, wherein the transparent material is indium tin oxide.

6. The electronic device according to claim 1,
wherein the at least one strain gauge is arranged in a leg of a Wheatstone bridge circuit.

7. The electronic device according to claim 1,
wherein the at least one strain gauge is arranged at a surface region of the electronic device such that the strain of the at least one strain gauge is influenced by a change of a temperature at the surface region of the electronic device.

8. The electronic device according to claim 1,
wherein the at least one function of the electronic device is a function of a heat management system of the electronic device.

9. The electronic device according to claim 1,
wherein the electronic device is a mobile device selected from a group consisting of a mobile phone, a personal digital assistant, a mobile music player, a mobile computer, a tablet computer, and a mobile navigation system.

10. A touch sensitive user interface for an electronic device, comprising:
a force detection arrangement comprising at least one sensor for detecting a force exerted by a user on a surface of the touch sensitive user interface, and
a control assembly for evaluating an output signal of the at least one sensor to determine a temperature of the touch sensitive user interface on the basis of the output signal and for generating a control signal to control at least one function of the electronic device.

11. An electronic device comprising the touch sensitive user interface according to claim 10.

12. The electronic device according to claim 11, wherein the electronic device is an electronic device comprising:
at least one strain gauge arranged at the electronic device such that a strain of the at least one strain gauge is influenced by a change of a temperature of the electronic device, and
a control assembly for evaluating an output signal of the at least one strain gauge to determine a temperature of the electronic device on the basis of the output signal and for controlling at least one function of the electronic device based on the determined temperature.

13. A method for determining a temperature of an electronic device, comprising the steps:
arranging at least one strain gauge at the electronic device such that a strain of the at least one strain gauge is influenced by a change of a temperature of the electronic device, and
evaluating an output signal of the at least one strain gauge to determine a temperature of the electronic device on the basis of the output signal.

14. The method according to claim 13,
further comprising the step of using an electronic device comprising at least one strain gauge arranged at the electronic device such that a strain of the at least one strain gauge is influenced by a change of a temperature of the electronic device, and
a control assembly for evaluating an output signal of the at least one strain gauge to determine a temperature of the electronic device on the basis of the output signal and for controlling at least one function of the electronic device based on the determined temperature.

15. A method for determining a temperature of a user interface of an electronic device, comprising the steps:
detecting an output signal of at least one sensor of a force detection arrangement of the touch sensitive user interface, wherein the at least one sensor of the force detection arrangement is provided for detecting a force exerted by a user on a surface of the touch sensitive user interface; and
determining a temperature of the touch sensitive user interface on the basis of an evaluation of the output signal of the at least one sensor.
